(19) United States
(12) Patent Application Publication
(10) Pub. No.: US 2025/0145055 A1
(43) Pub. Date: May 8, 2025

(54) METHOD AND SYSTEM FOR CONDITIONING BATTERY OF ECO-FRIENDLY VEHICLE USING DUAL BATTERY SYSTEM

(71) Applicants: Hyundai Motor Company, Seoul (KR); Kia Corporation, Seoul (KR)

(72) Inventors: Jeong Soo Park, Seoul (KR); Dae Won Yang, Seongnam-si (KR)

(21) Appl. No.: 18/609,218

(22) Filed: Mar. 19, 2024

(30) Foreign Application Priority Data
Nov. 8, 2023 (KR) 10-2023-0153624

(51) Int. Cl. B60L 58/27; B60L 58/13; B60L 58/40

(52) U.S. Cl. CPC B60L 58/27; B60L 58/13; B60L 58/40; B60L 2240/545; B60L 2260/52

(57) ABSTRACT

In an embodiment, an eco-friendly vehicle battery conditioning method or system includes, in a vehicle driven by first and second batteries, if an entrance condition for a regenerative conditioning mode is satisfied, comparing a temperature of the first battery with a target temperature, and driving the vehicle by using a regenerative conditioning mode if the temperature of the first battery is lower than the target temperature, where the regenerative conditioning mode corresponds to a mode in which the second battery is discharged while a motor is driven and the first battery is charged while power generation through the motor is performed.

### CROSS-REFERENCE TO RELATED APPLICATIONS

This application claims the benefit of Korean Patent Application No. 10-2023-0153624, filed on Nov. 8, 2023, which application is hereby incorporated herein by reference in its entirety.

### TECHNICAL FIELD

The disclosure relates to a battery management system.

### BACKGROUND

To drive motors, eco-friendly vehicles such as a hybrid electric vehicle (HEV), a plug-in HEV (PHEV), and an electric vehicle (EV) are equipped with a battery corresponding to a storage device for storing electric energy, and specifically, are equipped with a high-voltage battery that is different from a low-voltage battery mounted in an internal combustion engine vehicle in the conventional art.

The performance and efficiency of the battery may deteriorate depending on the outdoor temperature due to chemical characteristics of materials constituting such a high-voltage battery. Accordingly, the temperature of the high-voltage battery needs to be maintained at an appropriate temperature.

In relation thereto, “Electric vehicle that manages battery condition and battery conditioning management method” of Korean Patent Publication No. 10-2023-0040659 (published on Mar. 23, 2023) proposed a method for managing a battery condition by dividing a management mode of a battery to shorten a charging time of the battery and improve driving performance. However, a driving distance may be shortened because energy of a main battery is consumed to increase the temperature of the main battery when a conditioning function is used. In addition, when the main battery is operated in a low-temperature state, the battery efficiency is reduced, and the state of health (SOH) is negatively affected.

Accordingly, there is a need for a technology which enables the temperature of a main battery increased without consuming energy charged to the main battery, and enables a battery lifetime to be increased by preventing the main battery from being discharged in a low-temperature state.

### SUMMARY

The disclosure relates to a battery management system and, more specifically, to a method and a system for managing a main battery temperature of an eco-friendly vehicle using a dual battery system.

An embodiment of the present disclosure can enable the temperature of a main battery to be increased without consuming energy charged to the main battery.

In accordance with an embodiment of the present disclosure, a battery conditioning method and apparatus can be capable of increasing the temperature of the main battery by utilizing energy of a replaceable sub-battery and regenerative energy.

In accordance with an embodiment of the present disclosure, a battery conditioning method and apparatus can be capable of increasing a battery lifetime by preventing a main battery from being discharged in a low-temperature state.

In accordance with an embodiment of the present disclosure, a battery conditioning method and apparatus can be capable of retrieving energy through regenerative energy and increasing a distance to empty of a vehicle through a battery temperature increase effect.

The technical subjects pursued in the present disclosure are not necessarily limited to the above-mentioned technical subjects, and other technical subjects may be clearly understood, through the following descriptions, by those skilled in the art to which the present disclosure pertains.

According to an embodiment of the disclosure, a battery conditioning method includes, in a vehicle operated by power supplied from first and second batteries, comparing a temperature of the first battery with a target temperature if an entrance condition for a regenerative conditioning mode is satisfied, performing driving by using the regenerative conditioning mode if the temperature of the first battery is lower than the target temperature, wherein the regenerative conditioning mode corresponds to a mode in which the second battery is discharged when a motor is driven and the first battery is charged when power generation through the motor is performed.

A battery condition method may further include comparing an expected distance to a destination with a distance drivable using only power of the second battery when information on the destination is received from a user, and driving the vehicle by using the regenerative conditioning mode if the distance drivable using only power of the second battery is farther than the expected distance to the destination.

A battery conditioning method may further include alerting the user that the second battery can be discharged during driving of the vehicle if the distance drivable using only power of the second battery is not farther than the expected distance to the destination, and driving the vehicle by using the regenerative conditioning mode.

A battery conditioning method may further include comparing a state of charge (SOC) of the second battery with a threshold SOC, and driving the vehicle by using only power charged to the first battery if the SOC of the second battery is lower than the threshold SOC.

A battery conditioning method may further include comparing the temperature of the first battery with the target temperature if the SOC of the second battery is not lower than the threshold SOC, and driving the vehicle by using the regenerative conditioning mode if the temperature of the first battery is lower than the target temperature.

A battery conditioning method may further include determining whether the vehicle is in an ignition-ON state, and determining whether a request for regenerative conditioning mode driving is received from the user if the vehicle is in the ignition-ON state.

A battery conditioning method may further include driving the vehicle by using the regenerative conditioning mode if the information on the destination is not received from the user.

An entrance condition for the regenerative conditioning mode may be satisfied if a request for the regenerative conditioning mode is received from a user through an input of touching a driver-seat display screen.

A battery conditioning method may further include comparing the temperature of the first battery with the target temperature while the vehicle is driven using the regenerative conditioning mode, and turning off the regenerative conditioning mode and driving the vehicle if the temperature of the first battery is not lower than the target temperature.

A first battery may be a main battery of the vehicle and the second battery may be an auxiliary battery of the vehicle.

A battery conditioning system according to an embodiment of the disclosure includes first and second batteries configured to store power energy for driving a vehicle and a vehicle controller configured to compare a temperature of the first battery and a target temperature if an entrance condition for a regenerative condition mode is satisfied, and perform driving by using the regenerative conditioning mode if the temperature of the first battery is lower than the target temperature, where the regenerative condition mode corresponds to a mode in which the second battery is discharged when a motor is driven and the first battery is charged if power generation through the motor is performed.

A vehicle controller may be configured to compare a distance drivable using only power of the second battery with an expected distance to a destination if information on the destination is received from a user, and drive the vehicle by using the regenerative conditioning mode if the distance drivable using only power of the second battery is farther than the expected distance to the destination.

A vehicle controller may be configured to alert the user that the second battery can be discharged during driving of the vehicle if the distance drivable using only power of the second battery is not farther than the expected distance to the destination, and drive the vehicle by using the regenerative conditioning mode.

A vehicle controller may be configured to compare a state of charge (SOC) of the second battery with a threshold SOC, and drive the vehicle by using only power of the first battery if the SOC of the second battery is lower than the threshold SOC.

A vehicle controller may be configured to compare the temperature of the first battery with the target temperature if the SOC of the second battery is not lower than the threshold SOC, and drive the vehicle by using the regenerative conditioning mode if the temperature of the first battery is lower than the target temperature.

A vehicle controller may be configured to determine whether the vehicle is in an ignition-ON state, and determine whether a request for regenerative conditioning mode driving is received from the user if the vehicle is in the ignition-ON state.

A vehicle controller may be configured to drive the vehicle by using the regenerative conditioning mode if the information on the destination is not received from the user.

An entrance condition for the regenerative conditioning mode may be satisfied if a request for the regenerative conditioning mode is received from a user through an input of touching a driver-seat display screen.

A vehicle controller may be configured to compare the temperature of the first battery and the target temperature while the vehicle is driven using the regenerative conditioning mode, and turn off the regenerative conditioning mode and drive the vehicle if the temperature of the first battery is not lower than the target temperature.

A first battery may be a main battery of the vehicle and the second battery may be an auxiliary battery of the vehicle.

According to various embodiments of the disclosure above, discharging of a main battery in a low-temperature environment can be prevented, and thus a battery lifetime can be increased.

In addition, using an embodiment of the present disclosure, main battery energy does not need to be consumed to increase the temperature of the main battery, whereby a distance to empty of a vehicle can be increased.

Advantages provided by use of an embodiment of the present disclosure are not necessarily limited to the above-mentioned advantages, and other advantages may be clearly understood, through the following descriptions, by those skilled in the art to which the present disclosure pertains.

### BRIEF DESCRIPTION OF THE DRAWINGS

The above and other features and advantages of the present disclosure can be more apparent from the following detailed description taken in conjunction with the accompanying drawings, in which:

FIG. 1 is a block diagram schematically illustrating a battery conditioning system according to an embodiment of the disclosure;

FIG. 2A is a graph that illustrates a change in an SOC of a main battery according to driving of a motor of a normal eco-friendly vehicle;

FIG. 2B is a graph that illustrates a comparison with a change in an SOC of a main battery according to driving of a motor of an eco-friendly vehicle including a battery conditioning system according to an embodiment of the disclosure;

FIG. 3A is a diagram that illustrates a method of selecting a battery driven or regeneratively charged according to a temperature of a main battery in a driving mode and a regenerative mode according to an embodiment of the disclosure;

FIG. 3B is a diagram that illustrates a method of selecting a battery driven or regeneratively charged according to a temperature of a main battery in a driving mode and a regenerative mode according to an embodiment of the disclosure;

FIG. 4 is a flow chart illustrating a battery conditioning method according to an embodiment of the disclosure; and

FIG. 5 is a graph that illustrates a comparison between a change in an SOC of a battery of a normal eco-friendly vehicle according to vehicle driving and a change in an SOC of a main battery according to an embodiment of the disclosure.

### DETAILED DESCRIPTION OF ILLUSTRATIVE EMBODIMENTS

Hereinafter, embodiments disclosed in the present specification will be described in detail with reference to the accompanying drawings, and same or similar elements can be given same and similar reference numerals, and duplicate descriptions thereof may be omitted. The terms “module” and “unit” used for elements in the following description can be given or interchangeably used merely for the ease of writing the specification, and may not necessarily have distinct meanings or roles by themselves. In describing embodiments disclosed in the present specification, when the detailed description of the relevant known technology is determined to unnecessarily obscure the gist of the present disclosure, the detailed description of such may be omitted. Furthermore, the accompanying drawings are provided for easy understanding of the embodiments disclosed in the present specification, and the technical spirit disclosed herein is not necessarily limited to the accompanying drawings. Changes, equivalents, or substitutes can be included in the spirit and scope of the present disclosure.

Terms including an ordinal number such as “first”, “second”, or the like, may be used to describe various elements, but the elements are not necessarily limited by the terms because such terms can be used merely for the purpose of distinguishing one element from another element.

Where an element is referred to as being “connected” or “coupled” to any other element, it can be understood that another element may be provided therebetween, and that the element may be directly connected or coupled to the other element. In contrast, where an element is “directly connected” or “directly coupled” to any other element, it can be understood that no other element is present therebetween.

A singular expression may include a plural expression, unless they are definitely different in a given context. As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

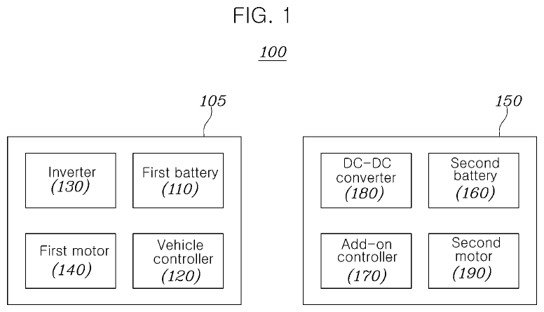

FIG. 1 is a block diagram schematically illustrating a battery conditioning system according to an embodiment of the disclosure.

Referring to FIG. 1, a battery conditioning system 100 according to an embodiment includes a main body 105 and an extended body 150.

The main body 105 may be a vehicle, and the extended body 150 may be a movable charger or a movable auxiliary battery connected for charging of a first battery 110 of a vehicle, for example.

The extended body 150 may be configured to be attachable to or detachable from the main body 105.

In FIG. 1, the battery conditioning system 100 according to an embodiment is illustrated to include the main body 105 and the extended body 150, but all elements of the main body 105 and the extended body 150 may be included in the main body 105.

The main body 105 includes a first battery 110, a vehicle controller 120, an inverter 130, and a first motor 140.

The first battery 110 can store power energy for driving the first motor 140.

The first battery 110 may be a main battery and the second battery 160 may be an auxiliary battery.

The vehicle controller 120 can compare the temperature of the first battery 110 with a target temperature if an entrance condition for a regenerative conditioning mode is satisfied, and perform driving by using the regenerative conditioning mode if the temperature of the first battery is lower than the target temperature.

The regenerative conditioning mode can be a mode in which the second battery is discharged when the motor is driven and the first battery is charged when power generation through the motor is performed.

The entrance condition for the regenerative conditioning mode may be determined to be satisfied when a request for regenerative conditioning mode driving is received from a user.

Whether the request for the regenerative conditioning mode is received from the user may be determined through transmission of a question, such as whether to drive the vehicle in a regenerative conditioning mode or a normal driving mode, through a display screen of a driving seat, and reception of a touch input from a driver.

In addition, the entrance condition for the regenerative conditioning mode may be determined to be satisfied when the vehicle is operated in the regenerative conditioning mode immediately before the vehicle is in an ignition-ON (IG-ON) state.

If the temperature of the first battery 110 is lower than a target temperature for driving the first motor 140, the vehicle controller 120 may drive the first motor 140 by using only power stored in the second battery 160 until the temperature of the first battery 110 reaches the target temperature.

The target temperature may be a temperature in which the motor can be driven with maximum power efficiency while the battery is discharged and the motor is driven.

The target temperature may be configured in a system by a user.

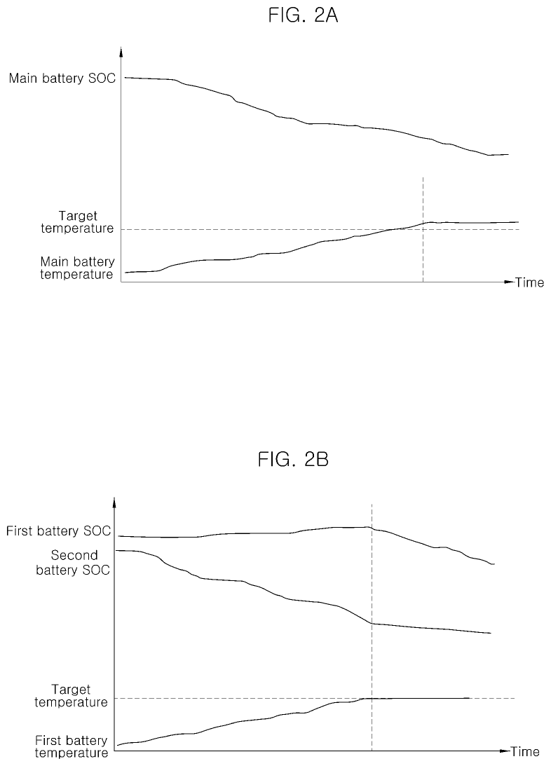

FIGS. 2A and 2B are graphs that illustrates a comparison between a change in an SOC of a main battery according to driving of a motor of a normal eco-friendly vehicle and a change in an SOC of a main battery according to driving of a motor of an eco-friendly vehicle including a battery conditioning system according to an embodiment of the disclosure.

Referring to FIG. 2A, it is assumed that in a normal eco-friendly vehicle, the vehicle is driven using only power of a main battery, and thus power for operating the vehicle is supplied from a battery in a low-temperature at the beginning of driving of the main battery, whereby the efficiency of the battery is decreased and the state of health (SOH) thereof is negatively affected.

On the other hand, referring to FIG. 2B, in an eco-friendly vehicle including a battery conditioning system according to an embodiment of the disclosure, the first motor 140 can be driven by using only power of the second battery 160 when the temperature of the first battery 110 is lower than the target temperature for driving the first motor 140, the first motor 140 is driven by using power of the first battery 110 and the second battery 160 after the temperature of the first battery 110 reaches the target temperature, and thus the battery efficiency and the SOH of the first battery 110, i.e., the main battery, can be enhanced.

The vehicle controller 120 may discharge or charge the battery in a driving mode in which the motor is driven by using power of the battery and a regenerative mode in which the battery is charged by using regenerative braking of the motor.

In the driving mode, the vehicle controller 120 may selectively supply power to the first motor 140 from one of the first battery 110 and the second battery 160 according to the temperature of the first battery 110.

In addition, the in the regenerative mode, the vehicle controller 120 may charge only the first battery 110 or simultaneously charge the first battery 110 and the second battery 160 according to the temperature of the first battery 110.

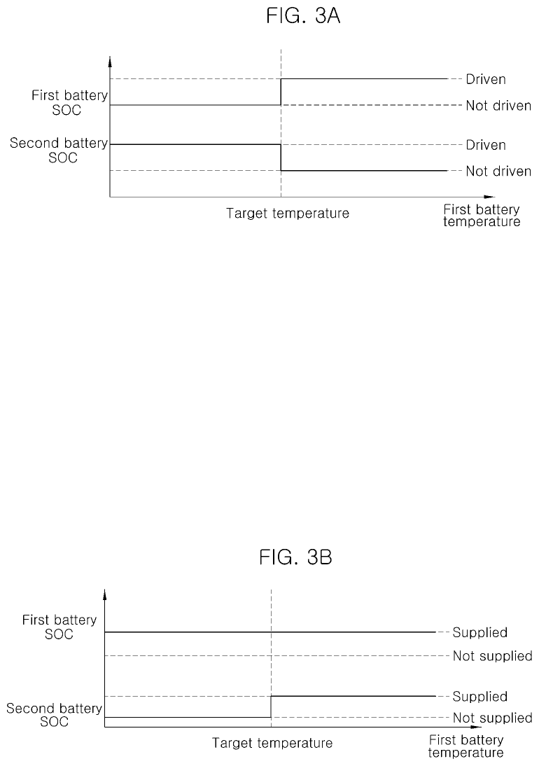

FIG. 3A is a diagram that illustrates a method of selecting a battery driven or regeneratively charged according to a temperature of a main battery in a driving mode and a regenerative mode according to an embodiment of the disclosure. FIG. 3B is a diagram that illustrates a method of selecting a battery driven or regeneratively charged according to a temperature of a main battery in a driving mode and a regenerative mode according to an embodiment of the disclosure.

Referring to FIG. 3A, it may be identified that in the driving mode, the vehicle controller 120 may supply power to the first motor 140 from the second battery 160 in a low-temperature state in which the temperature of the first battery 110 is lower than the target temperature, and supply power to the first motor 140 from the first battery 110 in a high-temperature state in which the temperature of the first battery is higher than the target temperature.

In addition, referring to FIG. 3B, it may be identified that in the regenerative mode, the vehicle controller 120 may supply power (e.g., charging) only to the first battery 110 from the first motor 140 in a low-temperature state in which the temperature of the first battery 110 is lower than the target temperature, and simultaneously supply power to the first battery 110 and the second battery 160 from the first motor 140 in a high-temperature state in which the temperature of the first battery 110 is equal to or higher than the target temperature.

The vehicle controller 120 can transmit, to an add-on controller 170, information indicating whether power is supplied from the second battery 160 to the first motor 140 in the driving mode, or power is supplied from the first motor 140 to the second battery 160 in the regenerative mode, based at least one input of information.

The information on at least one input may include at least one of a Cond_Rgn_MODE field indicating a regenerative conditioning mode indicating information on a user input to a request for entering into a regenerative conditioning mode in which the second battery 160 is used until the first battery 110 is increased to the target temperature, an MB_SOC field indicating information on a real-time residual SOC of the first battery 110, an SB_SOC field indicating information on a real-time residual SOC of the second battery 160, a Navi_DTE field indicating the distance to a destination on a navigation device, an MB_Temp field indicating the temperature of the first battery 110, an SB_Temp field indicating the temperature of the second battery 160, and a combination thereof.

The information transmitted from the vehicle controller 120 to the add-on controller 170 may include at least one of an Ev_Ready field indicating an ignition-ON (IG-ON) or ignition-OFF (IG-OFF) state of the vehicle, an SB_op_command field indicating an operation command of the second battery 160, and an SB_current_command field indicating an operation current command of the second battery 160, or any combination thereof.

In addition, the vehicle controller 120 may receive, from the add-on controller 170, information on whether the second battery 160 can be operated. The information on whether the second battery 160 can be operated may be indicated by an SB_op_avail field.

The vehicle controller 120 may identify whether the residual state of charge (SOC) of the first battery 110 is within an unstable area, to enter into a regenerative conditioning mode, and may release the regenerative conditioning mode as soon as the residual SOC of the first battery 110 enters a stable area.

Whether the SOC of the first battery 110 is within the stable area or the unstable area may be determined with reference to a pre-configured threshold SOC.

In addition, the vehicle controller 120 may determine whether to enter into the regenerative conditioning mode based on the residual SOC of the second battery 160.

For example, when the SOC of the second battery has a value smaller than a pre-configured threshold value, it may be configured that the regenerative conditioning mode is not to be used.

The inverter 130 can drive the first motor 140 on the basis of power supplied from the first battery 110 or the second battery 160 by control of the vehicle controller 120.

The first motor 140 can provide power for driving the main body 105 based on power output from the first battery 110 or the second battery 160.

The extended body 150 can include the second battery 160, the add-on controller 170, a DC-DC converter 180, and a second motor 190.

The second battery 160 can store energy for driving the first motor 140 or the second motor 190.

The add-on controller 170 can transmit information on whether the second battery 160 can be operated to the vehicle controller 120, and can receive, from the vehicle controller 120, information indicating whether power is supplied from the second battery 160 to the first motor 140 in the driving mode or power is supplied from the first motor 140 to the second battery 160 in the regenerative mode.

The DC-DC converter 180 can convert power of the first battery 110 to supply the converted power to the second battery 160, or can convert power of the second battery 160 to supply the converted power to the first battery 110.

The second motor 190 can provide power for driving the extended body 150 based on power output from the second battery 160.

The second motor 190 can be driven only in a single mode in which the extended body 150 is not attached to the main body 105.

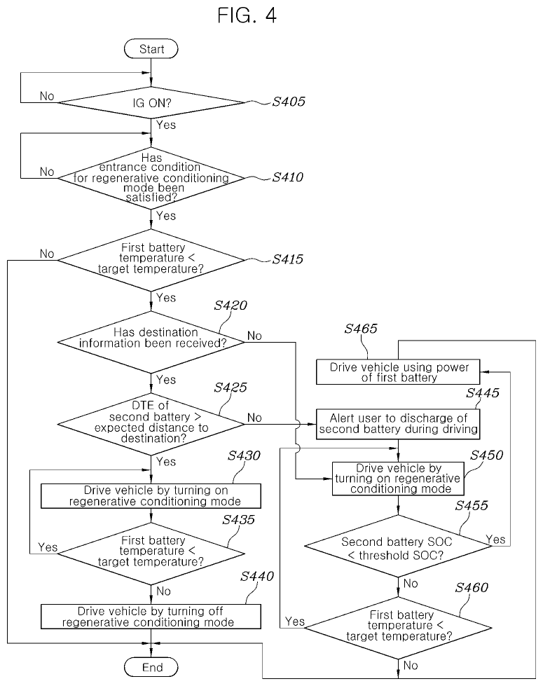

FIG. 4 is a flow chart illustrating a battery conditioning method according to an embodiment of the disclosure.

A battery conditioning method according to an embodiment may be performed by the vehicle controller 120 of FIG. 1.

Referring to FIG. 4, the vehicle controller 120 can determine whether a vehicle is in an ignition-ON (IG-ON) state (operation S405), can determine whether a request for driving in a regenerative conditioning mode is received from a user if the vehicle is in the ignition-ON (IG-ON) state (operation S410), and can determine whether the temperature of a first battery is lower than a target temperature if the request for driving in the regenerative conditioning mode is received (operation S415).

At operation S410, an entrance condition for the regenerative conditioning mode may be determined to be satisfied when the request for driving in the regenerative conditioning mode is received from the user.

Whether the request for driving in the regenerative conditioning mode is received from the user may be determined in response to a question whether to drive the vehicle in the regenerative conditioning mode or in a normal driving mode being transmitted through a driver-seat display screen and a touch input, which can be received from a driver.

In addition, the entrance condition for the regenerative conditioning mode may be determined to be satisfied when the vehicle is operated in the regenerative conditioning mode immediately before the vehicle is in the ignition-ON (IG-ON) state.

As a result of the determination in operation S415, if the temperature of the first battery is not lower than the target temperature, the regenerative conditioning mode of the vehicle is not necessary to be used, and thus the operation can end.

As a result of the determination in operation S415, if the temperature of the first battery is lower than the target temperature, the vehicle controller 120 can determine whether destination information is received from the user (operation S420), can determine whether the distance (distance to empty (DTE)) drivable using only power of the second battery 160 is farther than an expected distance to a destination (operation S425) if the destination information is received from the user, and can turn on a regenerative conditioning mode and drive the vehicle if the distance drivable using the second battery is longer than the expected distance to the destination (operation S430).

The regenerative conditioning mode can be a mode in which the second battery 160 is discharged while a first motor 140 is driven and the first battery 110 is charged while power generation through the first motor 140 is performed.

In addition, the vehicle controller 120 can determine whether the temperature of the first battery 110 is lower than a target temperature (operation S435), and can drive the vehicle in a state in which the regenerative conditioning mode is continuously turned on if the temperature of the first battery 110 is lower than the target temperature (operation S430).

As a result of the determination in operation S435, if the temperature of the first battery 110 is not lower than the target temperature, the regenerative conditioning mode can be turned off and the vehicle can be driven (operation S440).

As a result of the determination in operation S420, if the destination information is not received from the user, the vehicle controller 120 can drive the vehicle by turning on the regenerative conditioning mode (operation S450), can determine whether the state of charge (SOC) of the second battery 160 is lower than a threshold SOC (operation S455), and can determine whether the temperature of the first battery 110 is lower than the target temperature if the SOC of the second battery is lower than the threshold SOC (operation S460).

The threshold SOC may be configured as a value close to zero, and may be configured as, for example, 1%, 5%, or the like.

As a result of the determination of operation S425, if the distance drivable using only power of the second battery 160 is not farther than the expected distance to the destination, the vehicle controller 120 can alert the user to the possibility that the second battery can be discharged during the driving of the vehicle (operation S445), can drive the vehicle by turning on the regenerative conditioning mode (operation S450), and can determine whether the state of charge (SOC) of the second battery 160 is lower than the threshold SOC (operation S455).

As a result of the determination at operation S455, if the SOC of the second battery is lower than the threshold SOC, the first motor 140 can be driven using only power of the first battery 110 and the vehicle can be driven (operation S465).

As a result of the determination at operation S460, if the temperature of the first battery 110 is lower than the target temperature, the vehicle can be driven while the regenerative conditioning mode is continuously turned on (operation S450).

As a result of the determination at operation S460, if the temperature of the first battery 110 is not lower than the target temperature, the operation can end.

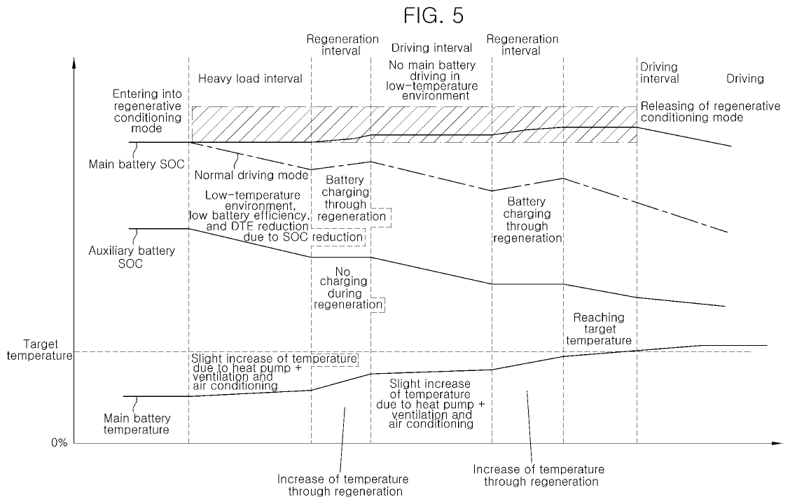

FIG. 5 is a graph that illustrates a comparison between a change in an SOC of a main battery of a vehicle in a normal driving mode and a change in an SOC of a main battery in a regenerative conditioning mode according to an embodiment of the present disclosure.

Referring to FIG. 5, in a normal driving mode, a vehicle can be driven by using only power of a main battery or the vehicle can be driven by simultaneously using power of the main battery and an auxiliary battery, and thus the motor can be driven with power charged to the main battery even before the temperature of the main battery reaches the target temperature, whereby the efficiency of the battery can be decreased and the state of health (SOH) thereof can be negatively affected.

However, in a case of driving a vehicle in a regenerative conditioning mode according to an embodiment of the present disclosure, until the temperature of the main battery reaches the target temperature, the vehicle can be driven by using only power charged to the auxiliary battery during driving of the vehicle, and because only the main battery is charged in a battery charging interval through regeneration of the motor, power charged to the main battery is not used for the driving of the vehicle until the temperature of the main battery reaches the target temperature.

Accordingly, in a case of driving the vehicle in the regenerative conditioning mode according to an embodiment of the present disclosure, the speed that the temperature of the main battery reaches the target temperature can be increased, the efficiency of the main battery can be increased, and the SOH of the main battery can be enhanced.

According to embodiments described above, the discharging of the main battery in a low-temperature environment can be prevented, and thus the lifetime of the main battery can be increased.

In addition, using an embodiment of the present disclosure, energy of the main battery does not need to be consumed to increase the temperature of the main battery, and thus the drivable distance of the vehicle can be increased.

An embodiment of the present disclosure, such as described above, can be implemented as codes in a computer-readable medium in which a program is recorded. The computer-readable medium can include all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, the like, or any combination thereof, for example. Furthermore, the above detailed description should not be construed in a limitative sense, but can be considered in an illustrative sense. The scope of the present disclosure can be determined by reasonable interpretation of the appended claims, and all changes and modifications within equivalent scopes of the present disclosure can fall within the scope of the present disclosure.

What is claimed is:

1. A vehicle battery conditioning method comprising:
in a vehicle operated by power supplied from a first battery and a second battery, comparing a temperature of the first battery with a target temperature if an entrance condition for a regenerative conditioning mode is satisfied; and
performing driving by using the regenerative conditioning mode if the temperature of the first battery is lower than the target temperature, wherein the regenerative conditioning mode corresponds to a mode in which the second battery is discharged while a motor is driven and the first battery is charged while power generation through the motor is performed.

2. The method of claim 1, further comprising:
comparing an expected distance to a destination with a distance drivable using only power of the second battery in response to information on the destination being received from a user; and
driving the vehicle by using the regenerative conditioning mode if the distance drivable using only power of the second battery is farther than the expected distance to the destination.

3. The method of claim 2, further comprising:
alerting the user to possible discharge of the second battery during driving of the vehicle if the distance drivable using only power of the second battery is not farther than the expected distance to the destination; and
driving the vehicle by using the regenerative conditioning mode.

4. The method of claim 3, further comprising:
comparing a state of charge (SOC) of the second battery with a threshold SOC; and
driving the vehicle by using only power charged to the first battery if the SOC of the second battery is lower than the threshold SOC.

5. The method of claim 4, further comprising:
comparing the temperature of the first battery with the target temperature if the SOC of the second battery is not lower than the threshold SOC; and
driving the vehicle by using the regenerative conditioning mode if the temperature of the first battery is lower than the target temperature.

6. The method of claim 1, further comprising:
determining whether the vehicle is in an ignition-ON state; and
determining whether a request for driving the vehicle by using the regenerative conditioning mode is received from a user if the vehicle is in the ignition-ON state.

7. The method of claim 2, further comprising driving the vehicle by using the regenerative conditioning mode if the information on the destination is not received from the user.

8. The method of claim 1, wherein the entrance condition for the regenerative conditioning mode is satisfied if a request for the regenerative conditioning mode is received from a user through a user input device.

9. The method of claim 1, further comprising:
comparing the temperature of the first battery with the target temperature while the vehicle is driven using the regenerative conditioning mode; and
turning off the regenerative conditioning mode if the temperature of the first battery is not lower than the target temperature.

10. The method of claim 1, wherein the first battery is a main battery of the vehicle and the second battery is an auxiliary battery of the vehicle.

11. A vehicle battery conditioning system comprising:
a first battery;
a second battery, wherein the first battery and the second battery are configured to store power energy for driving a vehicle; and
a vehicle controller configured to
compare a temperature of the first battery and a target temperature if an entrance condition for a regenerative condition mode is satisfied, and
perform driving by using the regenerative conditioning mode if the temperature of the first battery is lower than the target temperature, wherein the regenerative condition mode corresponds to a mode in which the second battery is discharged while a motor is driven and the first battery is charged if power generation through the motor is performed.

12. The system of claim 11, wherein the vehicle controller is further configured to:
compare a distance drivable using only power of the second battery with an expected distance to a destination if information on the destination is received from a user; and
drive the vehicle by using the regenerative conditioning mode if the distance drivable using only power of the second battery is farther than the expected distance to the destination.

13. The system of claim 12, wherein the vehicle controller is further configured to:
alert the user to possible discharge of the second battery during driving of the vehicle if the distance drivable using only power of the second battery is not farther than the expected distance to the destination; and
drive the vehicle by using the regenerative conditioning mode.

14. The system of claim 13, wherein the vehicle controller is further configured to:
compare a state of charge (SOC) of the second battery with a threshold SOC; and
drive the vehicle by using only power of the first battery if the SOC of the second battery is lower than the threshold SOC.

15. The system of claim 14, wherein the vehicle controller is further configured to:
compare the temperature of the first battery with the target temperature if the SOC of the second battery is not lower than the threshold SOC; and
drive the vehicle by using the regenerative conditioning mode if the temperature of the first battery is lower than the target temperature.

16. The system of claim 11, wherein the vehicle controller is further configured to:
determine whether the vehicle is in an ignition-ON state; and
determine whether a request for regenerative conditioning mode driving is received from a user if the vehicle is in the ignition-ON state.

17. The system of claim 12, wherein the vehicle controller is further configured to drive the vehicle by using the regenerative conditioning mode if the information on the destination is not received from the user.

18. The system of claim 11, wherein the entrance condition for the regenerative conditioning mode is satisfied if a request for the regenerative conditioning mode is received from a user through a user input device.

19. The system of claim 11, wherein the vehicle controller is further configured to:
compare the temperature of the first battery and the target temperature while the vehicle is driven using the regenerative conditioning mode; and
turn off the regenerative conditioning mode if the temperature of the first battery is not lower than the target temperature.

20. The system of claim 11, wherein the first battery is a main battery of the vehicle and the second battery is an auxiliary battery of the vehicle.
